(19) United States
(12) Patent Application Publication
(10) Pub. No.: US 2025/0175013 A1
(43) Pub. Date: May 29, 2025

(54) Method for controlling a charging apparatus

(71) Applicant: Hilti Aktiengesellschaft, Schaan (LI)

(72) Inventor: Wolfgang BECK, Schwabsoien (DE)

(21) Appl. No.: 18/842,855

(22) PCT Filed: Feb. 22, 2023
(86) PCT No.: PCT/EP2023/054467

§ 371 Date: Aug. 30, 2024

(30) Foreign Application Priority Data
Mar. 1, 2022 (EP) 22159559.8

(51) Int. Cl. H02J 7/00

(52) U.S. Cl. CPC H02J 7/00036; H02J 7/00045; H02J 7/0045; H02J 7/00712

(57) ABSTRACT

Method for controlling a charging process for at least one accumulator by a charging apparatus, wherein the accumulator contains a first communication device and the charging apparatus contains a second communication device, as a result of which the accumulator and the charging apparatus can communicate at least with each other. Charging apparatus for performing the method. Accumulator for performing the method. System containing a charging apparatus and at least one accumulator, which is able to be connected to the charging apparatus, for performing the method.

The present invention relates to a method for controlling a charging process for at least one accumulator by a charging apparatus, wherein the accumulator contains a first communication device and the charging apparatus contains a second communication device, as a result of which the accumulator and the charging apparatus can communicate at least with each other.

Moreover, the present invention relates to a charging apparatus for performing the method.

In addition, the present invention relates to an accumulator for performing the method.

Furthermore, the present invention relates to a system containing a charging apparatus and at least one accumulator, which is able to be connected to the charging apparatus, for performing the method.

### BACKGROUND

Accumulators are largely known from the prior art and can be used, inter alia, to be connected to power tools in such a way that the power tool can be supplied with electrical energy from the accumulator. For this purpose, the accumulator essentially contains a multiplicity of energy storage cells (also called accumulator cells) positioned in a solid housing. By means of the energy storage cells, electrical energy can be stored by the accumulator and also provided for a load (e.g. a power tool).

On one side of the housing of the accumulator, provision is made here for an interface by way of which the accumulator can be releasably connected either to a power tool or to a charging apparatus. In order to charge an accumulator with electrical energy, the accumulator is releasably connected to the charging apparatus. According to the prior art, the charging apparatuses have an interface on a top side of the housing of the charging apparatus, by way of which interface the accumulator is mechanically and electrically connected to the charging apparatus.

### SUMMARY OF THE INVENTION

Charging apparatuses, and in particular those which are used for charging the accumulators for power tools, have a relatively elaborate and complex configuration. The relatively elaborate and complex configuration of these charging apparatuses is due to the fact that the charging apparatuses are used, inter alia, in harsh or strenuous environments (e.g. on construction sites or in workshops) and at the same time sophisticated accumulators have to be supplied with electrical energy in—in some instances—complicated charging processes. For this purpose, these charging apparatuses, on the one hand, have to have a very solid and durable configuration and, on the other hand, have to be configured with sensitive technology.

The configuration of the interface on the charging apparatus constitutes a particular technical challenge here. This is because the interface is usually open at the top and the electrical connections are therefore also exposed to the risk of water and/or dust being able to penetrate through them into the interior of the charging apparatus. The penetrating water can lead, inter alia, to short circuits in the charging apparatus and consequently permanently damage the charging apparatus. Penetrating dust and other dirt can damage the charging apparatus as well.

It is an object of the present invention to solve the problem described above.

The present invention provides a method for controlling a charging process for at least one accumulator by a charging apparatus, wherein the accumulator contains a first communication device and the charging apparatus contains a second communication device, as a result of which the accumulator and the charging apparatus can communicate at least with each other.

According to the invention, the following method steps are provided
connecting the at least one accumulator to the charging apparatus;
transmitting at least one signal from the first communication device of the accumulator to the second communication device of the charging apparatus in order to convey at least one accumulator characteristic value;
transmitting at least one signal from the second communication device of the charging apparatus to the first communication device of the accumulator in order to indicate the charging capacity/compatibility for a charging process;
transmitting at least one signal from the first communication device of the accumulator to the second communication device of the charging apparatus in order to adjust the charging apparatus into a charging state;
adjusting the accumulator from a discharging state into a charging state;
transmitting at least one signal from the first communication device of the accumulator to the second communication device of the charging apparatus in order to adjust at least one first charging characteristic value at the charging apparatus;
transmitting electrical energy from the charging apparatus to the accumulator in accordance with at least one charging characteristic value demanded by the accumulator; and
transmitting at least one signal from the first communication device of the accumulator to the second communication device of the charging apparatus in order to adjust at least one second charging characteristic value at the charging apparatus if a predetermined duration and/or a predetermined state for the accumulator is reached.

According to one alternative embodiment, it can be possible for the at least one charging characteristic value to be a voltage value or current intensity value.

In accordance with one further alternative embodiment, it can be possible for the voltage value to be 21 to 60 V, in particular 48 V.

According to one alternative embodiment, it can be possible for the current intensity value to be 1 to 10 A, in particular 5 A.

In accordance with one further alternative embodiment, it can be possible for the charging power of the charging apparatus to be 21 to 600 W, in particular 240 W.

The object is moreover achieved by a charging apparatus for performing the method.

According to the invention, the charging apparatus contains a communication device and a charger interface device in order to selectively connect the charging apparatus to at least one accumulator, wherein the charger interface device is configured in the form of a USB plug.

In addition, the object is achieved by an accumulator for performing the method.

According to the invention, the accumulator contains a communication device and an accumulator interface device in order to selectively connect the accumulator to the charging apparatus, wherein the accumulator interface device is configured in the form of a USB socket.

Furthermore, the present invention provides a system containing a charging apparatus and at least one accumulator, which is able to be connected to the charging apparatus, for performing the method.

According to the invention, provision is made for the accumulator to contain a first communication device and an accumulator interface device, and for the charging apparatus to contain a second communication device and a charger interface device, such that the charging apparatus and the accumulator are able to be connected in order to charge the accumulator with electrical energy, wherein the charger interface device contains a USB plug and the accumulator interface device contains a USB socket.

### BRIEF DESCRIPTION OF THE DRAWINGS

Further advantages will become apparent from the following description of the figures. Various exemplary embodiments of the present invention are illustrated in the figures.

The figures, the description and the claims contain numerous features in combination. A person skilled in the art will expediently also consider the features individually and combine them to produce useful further combinations.

In the figures:

FIG. 1 shows a schematic side view of a charging apparatus according to a first embodiment and an accumulator, connected to the charging apparatus, according to a first embodiment; and

FIG. 2 shows a schematic side view of the charging apparatus according to a second embodiment and the accumulator, connected to the charging apparatus, according to a second embodiment.

### DETAILED DESCRIPTION

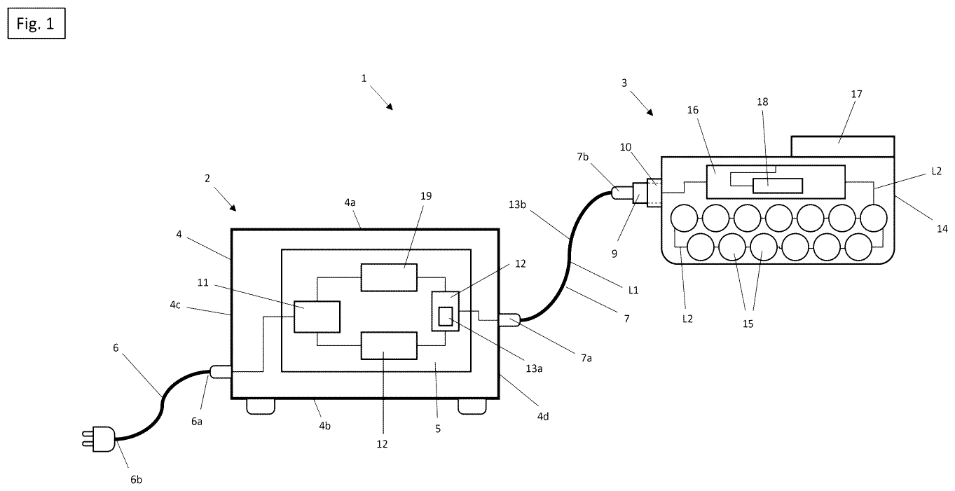

FIG. 1 shows a system 1 according to the invention made up of a charging apparatus 2 according to the invention and an accumulator 3 according to the invention according to a first embodiment. The charging apparatus 2 is used here to charge or supply the accumulator 3, which is able to be connected to the charging apparatus 2, with electrical energy.

The accumulator 3 can be used as a releasable energy supply for a power tool or the like.

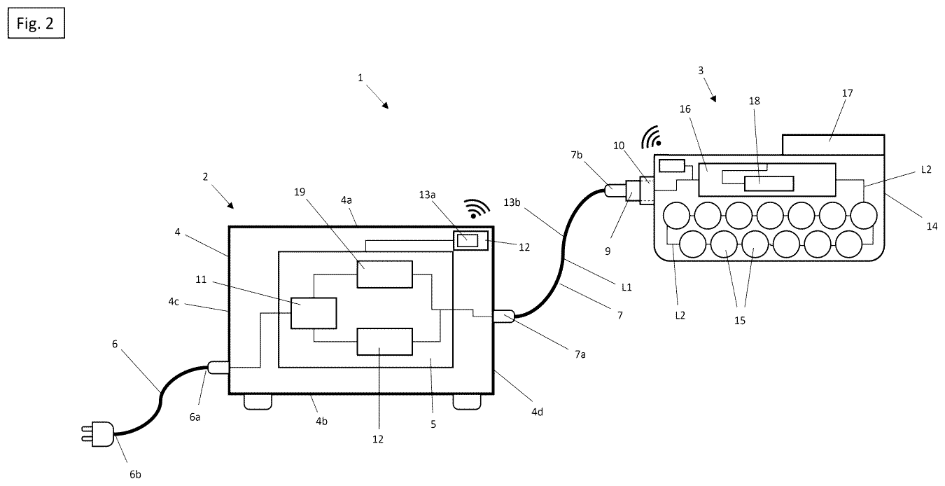

In FIGS. 1 and 2, only one single accumulator 3 is connected to the charging apparatus 2 by way of example. In accordance with an alternative embodiment not shown in the figures, it can be possible for the charging apparatus 2 to be configured to charge or supply more than one single accumulator 3 with electrical energy. In other words: the charging apparatus 2 can alternatively be capable of charging a plurality of accumulators 3 at the same time.

The charging apparatus 2 shown in FIG. 1 essentially contains a charger housing 4, a control device 5, a connector cable 6 and a charger interface device 7.

The charger housing 4 here has a top side 4a, bottom side 4b, a first side wall 4c, second side wall 4d, third side wall and fourth side wall. The third and fourth side walls are not shown in the figures.

The connector cable 6 is attached to the first side wall 4c and the charger interface device 7 is attached to the second side wall 4d.

The connector cable 6 contains a first end 6a and a second end 6b. The first end 6a attaches the connector cable 6 to the first side wall 4c of the charger housing 4. A plug 8 for a power outlet is positioned at the second end 6b of the connector cable 6, by means of which plug the connector cable 6 can be connected to a power outlet.

The charger interface device 7 is configured in the form of a first line L1 having a first and second end 7a, 7b. The first end 7a is attached to the second side wall 4d of the charger housing 4. A USB (Universal Serial Bus) plug 9 is positioned at the second end 7b of the charger interface device 7. The USB plug 9 is additionally configured to be releasably connected to a correspondingly designed USB socket 10.

As described below in more detail, the connection of the USB plug 9 to the USB socket 10 is used not only for transmitting electrical energy but also for transmitting or exchanging data and information in the form of electrical signals.

The control device 5 is positioned in the interior of the charger housing 4 and contains, inter alia, a current measuring device 11, voltage measuring device 12 and a communication device 13.

The control device 5 is used to control and regulate the individual functions of the charging apparatus 2. Among the various functions of the control device 5 are, inter alia, the adjusting of a particular voltage value or current intensity value for an electrical energy for charging an accumulator 3 which is connected to the charging apparatus 2.

The current measuring device 11 is used to measure or record a current intensity value.

The voltage measuring device 12 is in turn used to measure or record a voltage value.

The communication device 13 is used to send and receive electrical signals. The charging apparatus 2 can enter into communication with the accumulator 3 by means of the communication device 13. For this purpose, electrical signals for the exchange of data and information are sent and received between the charging apparatus 2 and the accumulator 3.

According to the first embodiment of the charging apparatus 2, the communication device 13 contains a communication element 13a and a transmission element 13b. The transmission element 13b is configured by the first line L1. Thus, by means of the first line L1, not only the electrical energy but also electrical signals for the exchange of data and information can be exchanged between the charging apparatus 2 and the accumulator 3.

The accumulator 3 essentially contains an accumulator housing 14, a multiplicity of energy storage cells 15, a control device 16, an accumulator interface device 17 and a communication device 18.

As indicated in FIG. 1, the energy storage cells 15 are electrically connected to each other and to the control device 16 by way of second lines L2. The connection allows electrical energy to be conducted from or to the energy storage cells 15.

The control device 16 is used to control and regulate the individual functions of the accumulator 3. Among the functions are, inter alia, the adjusting of a voltage value and of a current intensity value for the regulated output of electrical energy from the energy storage cells 15 to a power tool connected to the accumulator 3. The power tool is not illustrated in the figures.

The accumulator interface device 17 is designed in the form of a USB socket 10 in order to releasably connect to a correspondingly configured USB plug 9.

The communication device 18 of the accumulator 3 is used to send and receive electrical signals. The accumulator 3 can enter into communication with the charging apparatus 2 by means of the communication device 18. Electrical signals for the exchange of data and information are also hereby exchanged between the charging apparatus 2 and the accumulator 3.

By performing the method according to the invention for controlling a charging process for the accumulator 3 by the charging apparatus 2, the accumulator 3 is firstly releasably connected to the charging apparatus 2, as indicated in FIG. 1. In order to connect the accumulator 3 to the charging apparatus 2, the free end of the line L1 having the USB plug 9 of the charging apparatus 2 is connected to the USB socket 10 of the accumulator 3. As already mentioned above, by way of the connection of the USB plug 9 of the charging apparatus 2 to the USB socket 10 of the accumulator 3, electrical signals can be exchanged between the charging apparatus 2 and the accumulator 3.

After connecting the accumulator 3 to the charging apparatus 2, a signal is firstly sent from the communication device 18 of the accumulator 3 to the communication device 13 of the charging apparatus 2 in order to convey accumulator characteristic values. Conveying the accumulator characteristic values serves to identify the accumulator 3 to the charging apparatus 2. Through the identification, particular properties of the accumulator 3 are sent to the charging apparatus 2 in the form of the electrical signals. Among the properties of the accumulator 3 are, for example, a maximum permissible voltage value, current intensity value, temperature value or power value for charging the energy storage cells 15 with electrical energy.

After receiving the corresponding signal regarding the accumulator characteristic values, a signal is transmitted from the communication device 13 of the charging apparatus 2 to the communication device 18 of the accumulator 3 in order to indicate the charging capacity or compatibility of the charging apparatus 2 with the connected accumulator 3 for a charging process.

Subsequently and after receiving this signal, a further signal is sent from the communication device 18 of the accumulator 3 to the communication device 13 of the charging apparatus 2 in order to adjust the charging apparatus 2 into a charging state. The charging apparatus 2 is generally configured in such a way that it can be adjusted into a charging state, neutral state (also referred to as “stand-by”) or discharging charge. In the charging state, electrical energy can be sent from the charging apparatus 2 to a connected accumulator 3 which is suitable for a charging process. In the discharging state, electrical energy can be drawn from an accumulator 3 in order to be stored in a corresponding energy storage device 19 of the charging apparatus 2. The energy storage device 19 of the charging apparatus 2 can be an accumulator cell.

In the neutral state, electrical energy is neither drawn from a connected accumulator 3 into the charging apparatus 2 nor delivered from the charging apparatus 2 to a connected accumulator 3.

Subsequently, the accumulator 3 is adjusted from a discharging state into a charging state by way of its control device 16 such that electrical energy provided by the charging apparatus 2 can be drawn by the accumulator 3 and stored by the energy storage cells 15 of the accumulator 3.

After adjusting the accumulator 3 into the charging state, a further signal is sent from the communication device 18 of the accumulator 3 to the communication device 13 of the charging apparatus 2 in order to adjust at least one first charging characteristic value at the charging apparatus 2. The charging characteristic value can be a voltage value, current intensity value or a charging power value for the charging process.

The voltage value for the charging process can be 21 to 60 volts (V) here. According to the present embodiment, the voltage value is 48 V.

The current intensity value for the charging process can be 1 to 10 amperes (A). According to the present embodiment, the maximum current intensity value is 5 A.

The charging power for the charging process can be 21 to 600 watts (W). According to the present embodiment, the charging power is 240 W.

In a next method step, electrical energy is sent from the charging apparatus to the accumulator in accordance with at least one charging characteristic value demanded by the accumulator. In the present exemplary embodiment, the charging characteristic values for the connected accumulator correspond to a charging voltage of 48 V, a charging current intensity of 5 A and a resulting charging power of 240 W.

After a predetermined duration and/or after reaching a predetermined state for the accumulator 3, a further signal is sent from the communication device 18 of the accumulator 3 to the communication device 13 of the charging apparatus 2 in order to adjust at least one new charging characteristic value at the charging apparatus 2. The new charging characteristic value can be a new charging voltage value, charging current intensity value or charging power. The predetermined duration can be several minutes, for example between 5 and 30 minutes.

As indicated in FIG. 2, both the communication device 18 of the accumulator 3 and the communication device 13 of the charging apparatus 2 can be configured wirelessly and in particular by Bluetooth technology.

### LIST OF REFERENCE SIGNS

1 system
2 charging apparatus
3 accumulator
4 charger housing
4a top side of the charger housing
4b bottom side of the charger housing
4c first side wall of the charger housing
4d second side wall of the charger housing
5 control device of the charging apparatus
6 connector cable
6a first end of the connector cable
6b second end of the connector cable
7 charger interface device
7a first end of the charger interface device
7b second end of the charger interface device
8 plug
9 USB plug
10 USB socket
11 current measuring device
12 voltage measuring device
13 communication device
13a communication element
13b transmission element
14 accumulator housing
15 energy storage cells
16 control device of the accumulator
17 accumulator interface device
18 communication device of the accumulator
19 energy storage device of the charging apparatus
L1 first line
L2 second lines

What is claimed is:

1-8. (canceled)

9. A method for controlling a charging process for at least one accumulator by a charging apparatus, wherein the accumulator contains a first communication device and the charging apparatus contains a second communication device, the accumulator and the charging apparatus capable of being in communication via the first and second communication devices, the method comprising the following steps:
connecting the at least one accumulator to the charging apparatus;
transmitting at least one signal from the first communication device of the accumulator to the second communication device of the charging apparatus in order to convey at least one accumulator characteristic value;
transmitting at least one signal from the second communication device of the charging apparatus to the first communication device of the accumulator in order to indicate a charging capacity/compatibility for a charging process;
transmitting at least one signal from the first communication device of the accumulator to the second communication device of the charging apparatus in order to adjust the charging apparatus into a charging state;
adjusting the accumulator from a discharging state into a charging state;
transmitting at least one signal from the first communication device of the accumulator to the second communication device of the charging apparatus in order to adjust at least one first charging characteristic value at the charging apparatus;
transmitting electrical energy from the charging apparatus to the accumulator in accordance with at least one charging characteristic value demanded by the accumulator; and
transmitting at least one signal from the first communication device of the accumulator to the second communication device of the charging apparatus in order to adjust at least one second charging characteristic value at the charging apparatus if a predetermined duration or a predetermined state for the accumulator is reached.

10. The method as recited in claim 9 wherein the at least one charging characteristic value is a voltage value or current intensity value.

11. The method as recited in claim 10 wherein the at least one charging characteristic value is the voltage value and the voltage value is 21 to 60 V.

12. The method as recited in claim 11 wherein the voltage value is 48 V.

13. The method as recited in claim 10 wherein the at least one charging characteristic value is the current intensity value and the current intensity value is 1 to 10 A.

14. The method as recited in claim 13 wherein the current intensity value is 5 A.

15. The method as recited in claim 9 wherein a charging power of the charging apparatus is 21 to 600 W.

16. The method as recited in claim 15 wherein the charging power of the charging apparatus is 240 W.

17. A charging apparatus for performing the method as recited in claim 9, the charging apparatus comprising:
the second communication device; and
a charger interface to selectively connect the charging apparatus to the at least one accumulator, wherein the charger interface contains a USB plug.

18. An accumulator for performing the method as recited in claim 9, the accumulator comprising:
the first communication device; and
an accumulator interface to selectively connect the accumulator to the charging apparatus, wherein the accumulator interface is configured in the form of a USB socket.

19. A system comprising:
a charging apparatus and at least one accumulator able to be connected to the charging apparatus for performing the method as recited in claim 9, the accumulator including the first communication device and an accumulator interface, and the charging apparatus including the second communication device and a charger interface device, such that the charging apparatus and the accumulator are able to be connected in order to charge the accumulator with electrical energy, wherein the charger interface device contains a USB plug and the accumulator interface device contains a USB socket.
